(19) United States
(12) Patent Application Publication
(10) Pub. No.: US 2026/0105317 A1
(43) Pub. Date: Apr. 16, 2026

(54) INTENT RECOGNITION METHOD AND APPARATUS

(71) Applicant: Lenovo (Beijing) Limited, Beijing (CN)

(72) Inventors: Qingliang MIAO, Beijing (CN); Zeqing ZHAO, Beijing (CN); Yimin JING, Beijing (CN)

(21) Appl. No.: 19/358,708

(22) Filed: Oct. 15, 2025

(30) Foreign Application Priority Data
Oct. 16, 2024 (CN) 202411448437.1

(51) Int. Cl. G06N 3/096

(52) U.S. Cl. CPC G06N 3/096

(57) ABSTRACT

An intent recognition method includes obtaining question information, inputting the question information into a first model for information enhancement processing to obtain a first processing result, inputting the first processing result into a second model for intent recognition processing to obtain a second processing result that includes at least one candidate intent corresponding to the question information, and determining, based on the second processing result, a target intent corresponding to the question information. The first model is a large model and the second model is a deep learning model with an intent recognition speed faster than the large model for same question information.

### CROSS-REFERENCE TO RELATED APPLICATION

This application claims priority to Chinese Patent Application No. 202411448437.1, filed on October 16, 2024, the entire content of which is incorporated herein by reference.

### TECHNICAL FIELD

The present disclosure generally relates to the field of artificial intelligence applications, and, more particularly, to an intent recognition method and apparatus.

### BACKGROUND

In the present artificial intelligence (AI) landscape, intent recognition, as a key natural language processing (NLP) task, is widely used in scenarios such as intelligent customer service, voice assistants, search engines, or personalized recommendation systems. Its goal is to understand a true intent behind human language, thereby providing more personalized and efficient services.

In practical applications, intent recognition on an input user query is typically achieved by fine-tuning pre-trained models such as BERT using labeled data. However, this requires a large amount of labeled data, which not only increases data collection costs but also affects model generalization and scalability. Furthermore, when a user query is rich and colloquial, or even expresses multiple intents in a single sentence, the model struggles to accurately identify the true intent of the query, reducing the user interaction experience.

### SUMMARY

In accordance with the disclosure, there is provided an intent recognition method including obtaining question information, inputting the question information into a first model for information enhancement processing to obtain a first processing result, inputting the first processing result into a second model for intent recognition processing to obtain a second processing result that includes at least one candidate intent corresponding to the question information, and determining, based on the second processing result, a target intent corresponding to the question information. The first model is a large model and the second model is a deep learning model with an intent recognition speed faster than the large model for same question information.

Also in accordance with the disclosure, there is provided an electronic device including at least one memory storing program instructions, and at least one processor configured to execute the program instructions to obtain question information, input the question information into a first model for information enhancement processing to obtain a first processing result, input the first processing result into a second model for intent recognition processing to obtain a second processing result that includes at least one candidate intent corresponding to the question information, and determine, based on the second processing result, a target intent corresponding to the question information. The first model is a large model and the second model is a deep learning model with an intent recognition speed faster than the large model for same question information.

Also in accordance with the disclosure, there is provided a non-transitory computer-readable storage medium storing program instructions that, when executed by a processor, cause an electronic device including the processor to obtain question information, input the question information into a first model for information enhancement processing to obtain a first processing result, input the first processing result into a second model for intent recognition processing to obtain a second processing result that includes at least one candidate intent corresponding to the question information, and determine, based on the second processing result, a target intent corresponding to the question information. The first model is a large model and the second model is a deep learning model with an intent recognition speed faster than the large model for same question information.

### BRIEF DESCRIPTION OF THE DRAWINGS

To more clearly illustrate the technical solutions of the embodiments of the present disclosure, the drawings needed for use in the description of the embodiments will be briefly introduced below. The drawings described below are some embodiments of the present disclosure. For those of ordinary skill in the art, other drawings can be obtained according to these drawings without any creative work. Throughout the drawings, the same or similar reference numerals represent the same or similar elements. It should be understood that the drawings are schematic and that the originals and elements are not necessarily drawn to scale.

FIG. 1 is a flowchart of an intent recognition method consistent with embodiments of the present disclosure.

FIG. 2 is a flowchart of another intent recognition method consistent with embodiments of the present disclosure.

FIG. 3 is a flowchart of another intent recognition method consistent with embodiments of the present disclosure.

FIG. 4 is a flowchart of another intent recognition method consistent with embodiments of the present disclosure.

FIG. 5 is a flowchart of another intent recognition method consistent with embodiments of the present disclosure.

FIG. 6 is a schematic structural diagram of an intent recognition apparatus consistent with embodiments of the present disclosure.

FIG. 7 is a schematic structural diagram of an electronic device consistent with embodiments of the present disclosure.

### DETAILED DESCRIPTION OF THE EMBODIMENTS

Various schemes and features of the present disclosure are described herein with reference to the accompanying drawings. The terms used in the present disclosure are only used to explain the specific embodiments of the present disclosure and are not intended to limit the scope of the present disclosure. It is understandable to those skilled in the art that with the development of technology and the emergence of new scenarios, the technical solutions provided in the embodiments of the present disclosure are also applicable to similar technical problems.

The terms “first/second/third” involved in the present disclosure are only used to distinguish similar objects, and do not represent a specific order for the objects. It is understood that objects described by “first/second/third” can be interchanged with a specific order or sequence where permitted, such that the embodiments of the present disclosure described here can be implemented in an order other than that illustrated or described here. The terms “including,” “comprising,” or “having,” and any variations thereof, are intended to cover a non-exclusive inclusion, such that a process, method, system, product, or apparatus that comprises a list of elements is not necessarily limited to those elements but may include other elements not expressly listed or inherent to such process, method, product, or device. Unless otherwise defined, all technical and scientific terms used in the present disclosure have the same meaning as those generally understood by those skilled in the art. The terms used in the present disclosure are only for the purpose of description and are not intended to limit the scope of the present disclosure.

With rapid development of artificial intelligence (AI), the use of Large Language Models (LLMs) or large models (LMs) has been proposed to identify true intents of complex user queries. For example, prompt engineering is used to input a user query and an intent system into a large model/LLM, to leverage the model’s language understanding capabilities and accurately identify a true intent of each user query. When there are many intent categories, because of the limit of the context length of the LLM/large model, a rough recall of a list of candidate intents is needed before the LLM/large model determines the target intent of the user query. This requires the LLM/large model to be activated for a long time, increasing the intent recognition response time. The long-term use of an electronic device’s computing and memory resources results in excessive power consumption and affects other tasks performed by the electronic device.

The present disclosure provides an intent recognition method and apparatus thereof, to at least partially alleviate the above problems. A query input by a user, after information enhancement processing performed first using a large model, may be input to a deep learning model with a higher intent recognition response speed (whose model parameter amount is much less than the model parameter amount of the large model) for intent recognition processing. Based on an obtained processing result including at least one candidate intent corresponding to the user query, a target intent corresponding to the user query may be quickly and accurately determined. Compared with the implementation method of using only a large model to identify the true intent of the user query, the embodiments of the present disclosure may use the deep learning model to more quickly and accurately recall candidate intents corresponding to the user query, improving the accuracy and efficiency of the target intent recognition corresponding to the user query and reducing the startup time of the large model. Therefore, the occupancy of the computing and memory resources of the electronic device may be reduced, reducing the power consumption of the electronic device and the adverse effects on other tasks performed by the electronic device.

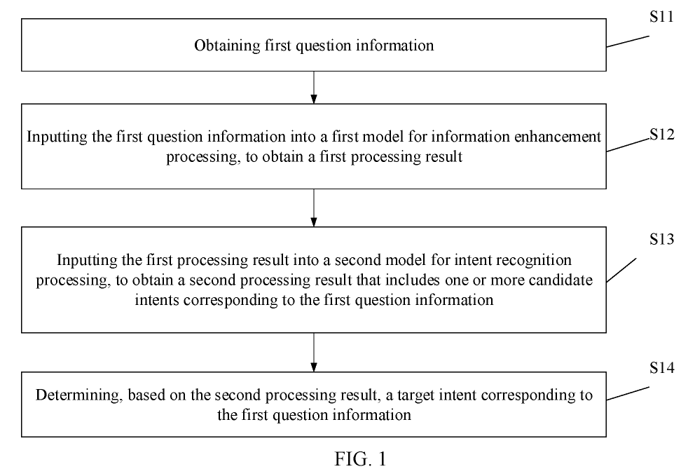

FIG. 1 is a flowchart of an intent recognition method provided by one embodiment of the present disclosure. The intent recognition method may be applied to an electronic device, such as a terminal device or a server. For example, the method may be applied to an application with question-and-answer processing functionality running on a terminal device or a cloud service provided by a cloud server. Or, the server may cooperate with the terminal device to implement the intent recognition method provided by the present disclosure. As shown in FIG. 1, the intent recognition method provided by this embodiment includes S11 to S14.

At S11, first question information input by a user is obtained.

In the embodiments of the present disclosure, the first question information may be a query input by the user using an input component of an electronic device (i.e., a user terminal). The first question information may include one or any combination of text, image, video, or audio information. Different types of first question information may be input using corresponding input components. The present disclosure does not limit the method for inputting the first question information.

For example, the user may input the first question information, such as “Check if the computer’s flight power mode has the manufacturer’s recommended custom settings,” “Query for pictures with the theme of AI transformation,” “Enable Bluetooth and eye protection mode,” or “Increase screen brightness a little more,” by voice. In another embodiment, the user may input the first question in a voice/text format, such as “Can you review this PPT for me? Please adjust the incoherent language and address unclear key points,” while simultaneously inputting or specifying a document. Based on actual task processing needs, the user may input the corresponding first question information to the electronic device using one or more appropriate input methods and language types. One piece of question information may correspond to one or more intents. The present disclosure does not limit the content of each piece of input first question information.

It should be understood that the first question information or an object to be processed included in the first question information (such as contents of a specified document, video, or image itself, or its access address) may also be inputted on a touch screen or its surroundings (such as selecting and entering various objects displayed on an interactive interface) using other input components such as a finger, stylus, mouse keys, or joystick. The electronic device may then receive the first question information inputted by the user in response to the input operation. The present disclosure may be able to flexibly select one or more combined input methods to complete the input operation of the first question information based on actual task processing needs, including but not limited to the implementation methods listed in the present disclosure.

At S12, the first question information is input into a first model for information enhancement processing, to obtain a first processing result.

In the embodiments of the present embodiment, to improve the response speed of intent recognition, rather than inputting the first question information into a large model for intent recognition and determining the actual intent corresponding to the first question information input by the user, the first question information may be pre-processed with information enhancement processing. This may allow the obtained first processing result to more clearly and specifically express various intents, such as the various intents involved in the first question information input by the user to request the electronic device to perform a desired task, compared to the first question information. The processing efficiency, reliability, and accuracy of the subsequent intent recognition processing steps may be improved.

In practical applications, the first model may utilize appropriate information enhancement (i.e., data augmentation) methods based on the semantic recognition results and the information type of the first question information to process the first question information input by the user into the first processing result consistent with the intent. The present disclosure does not limit the information enhancement methods used by the first model to process the input first question information.

For example, the original first question information may be processed by text transformation, expansion, or improvement. Deep learning/machine learning-based image data augmentation methods (such as one or any combination of adversarial generation, random flipping/scaling/attribute adjustment, or meta-learning data augmentation) may also be used to enhance the image data included in the first question information. For audio data included in the first question information or the voice signal input by the user, audio data enhancement processing may also be performed using one or more of methods including changing the volume or adjusting the speech rate. Based on actual needs, one or any combination of the text data augmentation methods, image data augmentation methods, or audio data augmentation methods may be flexibly selected, but the processing is not limited to these, which will not be described in detail here.

At S13, the first processing result is input into a second model for intent recognition, to obtain a second processing result. The first model may be a large model, and the second model may be a deep learning model with an intent recognition speed faster than the large model for the same question information. The second processing result may include at least one candidate intent corresponding to the first question information.

After using the large model to obtain the enhanced first processing result for the input first question information, in one embodiment, the second model with fewer model parameters (even at least one parameter order smaller) than the large model may be used to continue intent recognition processing on the first processing result. The second model may be typically a deep learning model with thousands or millions of model parameters, which may be equivalent to using a large model with millions, billions, or hundreds of billions of model parameters, to perform intent recognition processing on the first processing result. Therefore, the model computation workload during the intent recognition process may be significantly reduced, and the model response time may be shortened, thereby reducing the resource usage and power consumption of the electronic device during model startup, which may better adapt to resource-limited end-side devices (i.e., user terminals).

It should be noted that the present disclosure does not limit the network structure of the second model or its intent recognition processing method for the input first processing result. To avoid the second model being heavily dependent on labeled training data, which would result in excessively high costs for labeled training data and affect the generalization and scalability of the model, the second model may not be obtained by fine-tuning pre-trained models such as BERT. It may reuse deep learning models with intent recognition capabilities that electronic devices have or may call. The present disclosure does not limit the use method of the second model.

The present disclosure may use the second model to perform intent recognition on the first processing result, quickly and accurately obtaining all possible true intents corresponding to the first question information (these true intents may be recorded as target intents). These possible true intents may be recorded as candidate intents, which may be equivalent to directly and roughly retrieving the candidate intents from the intent library. Therefore, the recall rate of the true intents may be improved. The number of candidate intents included in the second processing result obtained by the second model may be determined based on actual conditions and a pre-configured recall rate (which may be configured based on experiments or experience). The present disclosure does not limit the content of the first processing result.

At S14, a target intent corresponding to the first question information is obtained based on the second processing result.

In conjunction with the above description of the at least one candidate intent corresponding to the first question information in the second processing result, the at least one candidate intent may be directly analyzed based on the intent recognition accuracy/confidence by the second model for each candidate intent to determine the target intent corresponding to the first question information., For example, one candidate intent with the highest second model intent recognition accuracy or that meets a specified preset accuracy may be selected as the target intent. Alternatively, the large model’s language understanding capabilities may be leveraged to accurately and fully understand each candidate intent and determine the target intent corresponding to the first question information. The present disclosure does not limit the implementation of S14.

In summary, during the intent recognition process for the first question information input by the user, the present disclosure may first utilize the large model to perform flexible and reasonable information enhancement processing on the first question information, which ensures that the resulting first processing result may be consistent with the intent of the first question information and more clearly and accurately expresses each intent, thereby improving the efficiency and accuracy of subsequent intent recognition processing. During subsequent intent recognition, the present disclosure may utilize a deep learning model or a second model to perform faster intent recognition than the large model. This model may quickly and accurately obtain the second processing result including the at least one candidate intent corresponding to the first question, thereby efficiently and accurately determining the target intent corresponding to the first question information.

Throughout the entire intent recognition process, the large model may not be constantly engaged, which would otherwise consume significant computing and memory resources in the electronic device, thus reducing power consumption. Furthermore, the present disclosure may use the large model to first enhance the first question before inputting it into the second model for intent recognition. Compared to directly inputting the first question into the second model for intent recognition, the accuracy and reliability of intent recognition may be improved, particularly for user queries with complex first questions or ambiguous verbal expressions, thereby ensuring a better user experience.

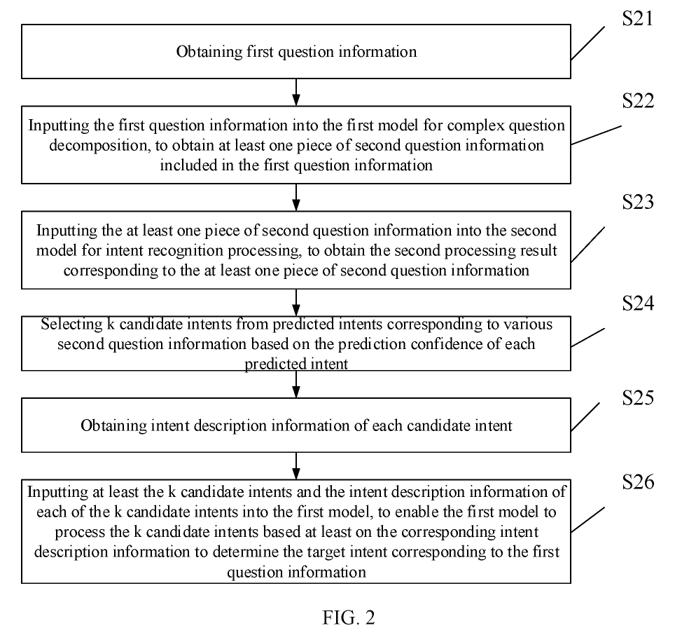

FIG. 2 is a flowchart of an intent recognition method provided by another embodiment of the present disclosure. This embodiment describes an optional refinement of the above-mentioned intent recognition method for obtaining the second processing result of the first question information using the first model and the second model. In the case where the first model is a large model, the second model may be a deep learning model that recognizes intent for the same question information faster than the large model, and the number of model parameters of the second model may be significantly smaller than that of the first model, as shown in FIG. 2, the intent recognition method may include S21 and S22.

At S21: the first question information input by the user is obtained.

The input method and content of the first question information may refer to, but may not be limited to, the description of the corresponding sections of the above-mentioned embodiments, such as the description of S11, which will not be described in detail in this embodiment.

At S22, the first question information is input into the first model for complex question decomposition, to obtain at least one piece of second question information included in the first question information. One piece of second question information may have a single or simple intent, while the first question information may have multiple or complex intents.

Based on the above analysis of the technical solution proposed in the present disclosure, to improve the second model’s intent recognition accuracy, a complex user-input query (question information), i.e., the first question information with multiple or complex intents, may be decomposed using the large model. The first question information may be processed into the at least one piece of second question information, each of which may have a single or simple intent. This may avoid inputting complex question information into the second model, ensuring the accuracy and reliability of intent recognition by the second model from the source of the input.

An intent of a query (question information) may generally refer to actual needs or purposes expressed or potentially implied by the user in the query information. Intents may be categorized into simple and complex intents based on factors such as the clarity and diversity of the user’s needs or the complexity of the operations needed to execute the query. Therefore, in the present disclosure, a simple intent may refer to an intent that has a single purpose (i.e., the user’s need may be very clear, usually involving only one action or information point), is straightforward (i.e., the user’s question or request is able to be understood without additional contextual information), is easy to understand (i.e., the model is able to easily identify the user’s need and directly provide an answer to the question or perform the corresponding action), does not require complex reasoning (i.e., does not require in-depth analysis or reasoning of the user’s intent), or has few parameters or conditions (i.e., does not require multiple parameters or conditions to define the answer to the question or the needed action).

Correspondingly, in the present disclosure, a complex intent may refer to an intent that has multiple purposes (i.e., the user’s need involves multiple actions or information points, and may need to meet multiple conditions at the same time), is implicit or vague (i.e., the user’s query may contain an implicit intent, and the true intent/actual need or purpose need to be clarified through context or additional information), requires complex parsing (i.e., the model needs to perform complex semantic analysis or reasoning to understand the user’s need), involves multiple steps (i.e., it may be necessary to perform multiple steps, operations or candidate solutions to meet the user’s query, such as filtering first and then sorting, etc.), has many parameters or conditions (i.e., the user’s query may involve multiple parameters or conditions, and multiple factors need to be considered comprehensively), or involves tasks outside the intent system (i.e., the task may not be a task within the intent system, but requires a combination of multiple intents in the intent system to achieve the task).

The needs of a query with a simple intent may be clear and direct, and the simple query may usually belong to a single intent. However, a single intent of a query does not necessarily belong to a simple intent. A single intent with at least one characteristic as described above for a complex intent may also be a complex intent. Usually, an intent of a query with multiple intents may belong to a complex intent. Since the second model has a limited ability to understand question information with complex intents, it may be difficult to fully and accurately identify the various intents or complex intents of the question information. In the present disclosure, the large model may be called to decompose the first question information with complex intents or multiple intents, to ensure that the intent of the second question information subsequently input to the second model is simple and single. Therefore, the second model may be able to accurately identify the intent corresponding to the input question information based on its own limited understanding ability.

In some embodiments, such as when a user continuously inputs multiple question information to express a scenario with multiple rounds of intents, the expression of question information that is not input for the first time may be relatively concise. For example, objects/content that already exist in the historical question information input adjacent may be omitted or pointed to. The user’s intent cannot be identified only through the question information input this time. For example, the user may input “increase the screen brightness” in the first round and “higher” in the second round. The first question information of “higher” may not clearly express the user’s actual needs or purposes, and the model cannot directly identify the intent from it. In response to this scenario, the first question information currently input by the user may be rewritten in combination with the context of the question information, to obtain a simple and clear expression of the intent. For example, “higher” may be rewritten as “make the screen brightness higher,” and so on.

Correspondingly, at S22, after the first question information is input into the first model, the first model may obtain the historical question information input adjacent to the first question information, perform semantic analysis on the historical question information and the first question information, and obtain the at least one piece of second question information included in the first question information. As in the example above, the first model may determine the intent of the first question information or the sentence it contains that is unclear in expression of intent based on the results of semantic analysis, and accordingly change the first question information or the sentence it contains into the second question information whose intent is simple and clear.

In some other embodiments, combined with the above description of the complex intents or multiple intents of the first question information, the large model may use a complex question decomposing method to split the first question information into multiple pieces of second question information, ensuring that each piece of second question information includes a simple intent or a single intent. That is, the first question information may be input into the first model for intent recognition, and based on the multiple intents or complex intents of the first question information, the first question information may be decomposed into multiple pieces of second question information.

In actual applications, the first question information with complex intents or multiple intents may belong to a complex query, which usually includes multiple parameters or conditions, connections, sub-questions, grouping/sorting, or other intent expressions. The decomposing methods corresponding to the first question information with different intent expressions may be different, such as the conditional decomposition method based on logical symbols, the sub-question decomposition method, or the index-based decomposition method. For these decomposing methods, in the present embodiment, corresponding complex question decomposition prompt words may be preconfigured. Based on this, in some embodiments, the first question information may also be subjected to semantic or structural analysis, and after determining the matching complex question decomposition prompt words, the first question information and the complex question decomposition prompt words may be input into the large model. Based on the complex question decomposition prompt words, the large model may be guided to decompose the first question information into the multiple pieces of second question information.

For example, the first question information input by the user is: “Turn on Bluetooth and eye protection mode.” The first question information may be input into the large model for intent recognition, and it is determined that the first question information includes two intents, and may be decomposed into two second question information, each of which expresses a single intent, such as “Turn on Bluetooth” and “Turn on eye protection mode.” The first question information including the logical symbol “and” may be analyzed, and the decomposition condition prompt words based on the logical symbol and the first question information are input into the large model. According to the decomposing method represented by the prompt words, the clauses connected by the logical symbol in the question information may be split into independent sentences with clear intents, and the two clauses connected by “and” in the first question information may be split into independent second question information. The present disclosure does not limit the various complex problem decomposition methods.

In some other embodiments, combined with the relevant description of complex intents above, when the intents of the first question information input by the user are vague or implies multiple intents/complex intents (that is, include multiple/complex potential intents), the large model may use its own knowledge to semantically understand the first question information during the complex problem decomposition of such first question information, analyze the various potential/implicit intents for realizing the task corresponding to the first question information, such as the intent corresponding to at least one execution plan/strategy for realizing the task, and then obtain the second question information for each intent based on this.

For example, the first question information input by the user is “eyes are uncomfortable.” To solve the task of user’s eye discomfort, the execution plan/strategy generated or selected by the large model may include lowering the device screen brightness, reducing blue light, adjusting the font size of the displayed content, adjusting the brightness of the ambient light, turning off the screen for a preset period of time and then restoring it, calling a specified service (such as an eye examination appointment service, etc.), or other task description information. For each execution plan/strategy, there may be at least one intent. The large model may decompose the complex problem of “eyes are uncomfortable” and obtain the second problem information including a single intent/simple intent based on at least one intent corresponding to at least one execution plan/strategy that matches or is selected, such as the task description information corresponding to the execution plan/strategy, or decomposing the task description information including multiple intents/complex intents into the second question information including a single intent/simple intent, etc.

At S23, the at least one piece of second question information is input into the second model for intent recognition, to obtain a second processing result corresponding to the at least one piece of second question information. The second processing result may include at least one predicted intent corresponding to the corresponding second question information and a prediction confidence corresponding to each predicted intent.

Combined with the above description of the second model, after the large model processes the first question information into the at least one piece of second question information using appropriate information enhancement methods, each piece of second question information may have a single or simple intent. The second question information may be input into the second model for intent prediction, to accurately obtain each predicted intent corresponding to the second question and its corresponding prediction confidence. The prediction confidence may be the probability that the predicted intent corresponding to the second question is the true intent of the second question information. A higher prediction confidence may indicate a higher probability that the predicted intent is the true intent of the second question. The present disclosure does not limit the intent prediction steps performed by the second model on each second question.

In one embodiment, in the above intent prediction process, when the first question information includes multiple pieces of second question information, the multiple pieces of second question information may be sequentially input into the second model. The second model then may perform intent prediction on each input second question information, to obtain at least one predicted intent and its corresponding prediction confidence. Alternatively, in another embodiment, all of these multiple pieces of second question information may be input into the second model, and the intent prediction may be performed to obtain a second processing result for each piece of second question information.

At S24, based on the prediction confidence, k candidate intents are selected from the predicted intents corresponding to various second question information.

After obtaining the second processing result corresponding to each piece of second question information, based on the prediction confidences included in the second processing results, the corresponding predicted intents included in the second processing results may be selected as candidate intents based on the prediction confidences of the predicted intents obtained by the second model. The specific implementation is not limited in the present disclosure.

In a possible implementation of determining at least one candidate intent of the first question information included in the second processing results, for each piece of second question information having the second processing result, based on the prediction confidence of at least one predicted intent corresponding to this second question information, the candidate intent of the second question information may be selected from the at least one predicted intent corresponding to the second question information in a manner described above. When the first question information includes one piece of second question information, the candidate intents of the second question information selected may be all the candidate intents corresponding to the first question information. When the first question information includes multiple pieces of second question information, the candidate intents of the second question information selected may be part of all the candidate intents corresponding to the first question information.

Therefore, when the first question includes multiple pieces of second question information, the candidate intent corresponding to each second question may be selected according to the candidate intent determination method described above. The candidate intents corresponding to each of these multiple pieces of second question information may then be used to form the total candidate intents corresponding to the first question information (i.e., the k candidate intents mentioned above). The number k of candidate intents corresponding to the first question information determined by this method may be an integer larger than 2, including at least one predicted intent from each piece of second question information.

In another embodiment, the prediction confidences of all predicted intents corresponding to all second question information may be sorted, and then k (which is an integer larger than or equal to 1) predicted intents with higher prediction confidences or those whose prediction confidences meet a certain threshold may be selected as candidate intents. In this case, the at least one candidate intent determined for the first question information may not necessarily include the predicted intents of each piece of second question information. Predicted intents corresponding to second question information that are not included may be generally unlikely to be the actual intent expressed or potentially underlying the first question information and may be directly eliminated to reduce subsequent computational effort.

At S25, intent description information for each candidate intent is obtained.

At S26, at least the k candidate intents and their intent description information are input into the first model, and the k candidate intents are processed at least based on the corresponding intent description information, to determine the target intent corresponding to the first question information.

In the embodiments of the present disclosure, according to but not limited to the method described above, after screening at least one candidate intent corresponding to the first question information from the predicted intents corresponding to the at least one piece of second question information included in the first question information predicted by the second model, to improve intent recognition accuracy, the large model may be further invoked to process all screened candidate intents to determine the target intent corresponding to the first question.

In one embodiment, to enable the large model to better understand the definition of intents, i.e., intent description information, the intent description information corresponding to different categories of intents may be configured based on corresponding domain experts or industry knowledge. For example, the intent description information of the intent “Get factory information of non-local devices” may be “Query the factory information of non-local electronic devices”; the intent description information of the intent “Get device brand” may be “What brand is my computer?”; or the intent description information of the intent “Project to my PC” may be “ the feature of Project to My PC allows wireless projection of content from mobile devices to Windows PCs for easy sharing and display on larger screens.

Therefore, the present disclosure may be able to correctly understand the k candidate intents by learning from the large model or based on the intent description information of each of the k selected candidate intents, and adopt a reasonable and correct processing method to process the k candidate intents, to ensure that the target intent corresponding to the first question information may be the true intent. For example, the first question information input by the user may be “What is the model of Dongfanghong-3?.” According to the method described above, the corresponding candidate intent may be determined to include the intent of “obtaining the brand of the device.” Through its intent description information, it may be determined whether the intent is the true intent of the first question information, or whether the degree of match with the first question information is large enough to indicate that the intent is the target intent, etc.

It should be understood that the definition description of one or more selected candidate intents may be different in different fields/industries or enterprises, or it may be a custom intent in a specific field/enterprise. For example, the meaning of “upper screen” in the intent of “adjusting the brightness of the upper screen” may be unclear, resulting in the large model being unable to accurately determine whether this intent is the true intent. Therefore, to ensure that the large model correctly understands the intent of the candidate intent within the specific field/enterprise to which the first question information belongs/is involved, before inputting the k candidate intents into the large model, the intent description information of each of the k candidate intents may be obtained first. The present disclosure does not limit the source of the intent description information of each candidate intent (that is, the definition description of the intent category to which each candidate intent belongs). It may be obtained from the intent system database, or it may be queried from the knowledge base of a specific field/enterprise, etc.

Afterwards, in one embodiment, at least the k candidate intents and the intent description information of each candidate intent may be composed to form an intent processing prompt information prompt. For example, at least the k candidate intents and the intent description information of each candidate intent may be spliced to obtain the prompt, and then the prompt may be input into the large model, so that the large model may sort or select these k candidate intents according to the intent description information in the prompt and determine the target intent corresponding to the first question information. The target intent may be the true intent of the first question information determined by the large model, which may be one or more candidate intents that are most likely to be the true intent among the k candidate intents, or the intent generated by these one or more candidate intents (i.e., the extended intent), etc. The present disclosure does not limit how the large model processes the k candidate intents and determines the implementation method of the target intent corresponding to the first question information, which may be determined based on actual conditions.

In some other embodiments, the large model may be pre-fine-tuned, such that the adjusted first model may understand each candidate intent. The k candidate intents may be input into the tuned first model, such that the k candidate intents may be processed by the tuned first model to determine the target intent corresponding to the first question information. Based on this, fine-tuned data based on the k candidate intents may be obtained, and may be used to fine-tune the parameters of the first model to obtain the tuned first model that is able to understand the k candidate intents.

In one possible embodiment, the intent description information of each candidate intent may be determined as fine-tuning data after obtaining the intent description information of each candidate intent, or the intent description information may be used to constitute fine-tuning data to achieve parameter fine-tuning of the large model, such that the tuned first model is able to understand the definition and boundaries of each candidate intent in advance. In this case, the k candidate intents screened out may be input into the first model for processing to determine the target intent corresponding to the first question information.

In some other embodiments, to improve the reliability and accuracy of the first model in determining the target intent corresponding to the first question information, in addition to obtaining the intent description information of each candidate intent, historical interaction information (such as historical conversation information) that matches the first question information may also be obtained. The k candidate intents, the intent description information of each candidate intent, and the historical interaction information may then be input into the first model, and the first model may process the k candidate intents based on the intent description information and the historical interaction information to determine the target intent corresponding to the first question information. Compared with S26, in this embodiment, combined with the historical interaction information, the true intent expressed or potentially expressed by the first question information may be understood more accurately, and, after correctly understanding the k candidate intents based on the intent description information, the k candidate intents may be more reasonably processed (using one or more of sorting, selecting, expanding, or other processing methods), thereby improving the accuracy and reliability of the determined target intent.

In the present disclosure, the first question information may be input into the large model for complex problem decomposition, ensuring that each of the at least one piece of second question information obtained is question information including a single intent or a simple intent. Then, the second question information may be input into the second model with a faster intent recognition speed than the large model, for intent recognition. Through the limited language understanding ability of the second model, it may also accurately determine at least one predicted intent corresponding to each piece of second question information and its corresponding prediction confidence. Then, based on the predicted probability that the corresponding predicted intent represented by the prediction confidence is the true intent, the k candidate intents corresponding to the first question information may be selected from all predicted intents. This process may not require starting the large model to occupy a large amount of computing and memory resources of the electronic device. Since the model parameters of the second model are much less than those of the large model, the resource consumption of the electronic device may be greatly reduced, and the intent recognition processing speed may be improved. Afterwards, at least the k candidate intents and their corresponding intent description information may be input into the large model, such that the large model correctly understands the corresponding candidate intents at least based on the intent description information, realizes reasonable processing of the k candidate intents, and ensures the accuracy and reliability of the target intent corresponding to the first question information determined thereby.

The intent recognition method provided by the present disclosure may significantly reduce the startup time of the large model and the power consumption of electronic devices compared to implementation methods that only call upon a large model to identify the target intent based on the first question information, which makes it more suitable for end-side devices with limited computing and memory resources. Compared to implementation methods that fine-tune intent recognition based on pre-trained models such as BERT, the method provided by the present disclosure may accurately identify complex or ambiguous target intents, therefore improving intent recognition accuracy. The large model may process input question information of any length, improving the user interaction experience, eliminating the need for excessive reliance on labeled training data, reducing labeled training data costs, and improving model generalization and scalability.

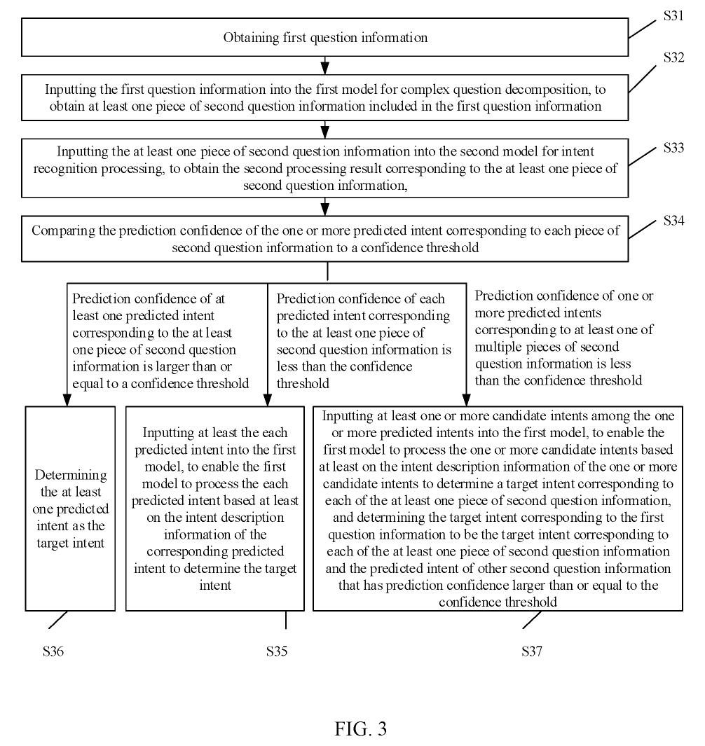

FIG. 3 is a flowchart of another intent recognition method provided by another embodiment. This embodiment describes another possible refinement of the intent recognition method proposed above, which determines the target intent corresponding to the first question information based on the second processing result. As shown in FIG. 3, in this embodiment, the intent recognition method includes S31 to S37.

At S31, first question information input by a user is obtained.

At S32, the first question information is input into a first model to perform complex question decomposition, thereby obtaining at least one piece of second question information included in the first question information, where each piece of second question information may have a single intent or a simple intent while the first question information may have multiple intents or a complex intent.

At S33, the at least one piece of second question information is input into a second model to perform intent recognition, thereby obtaining a second processing result corresponding to the at least one piece of second question information. Each second processing result may include at least one predicted intent corresponding to the corresponding second question information and a prediction confidence corresponding to each predicted intent.

For S31-S33, references may be made to the corresponding descriptions in the preceding embodiments, such as the corresponding descriptions of S21-S23, which will not be further elaborated here.

At S34, the prediction confidence of the predicted intent corresponding to each piece of second question information is compared with a confidence threshold.

In this embodiment, since the second model predicts intent for each piece of second question information with a single intent or a simple intent, at least one predicted intent corresponding to the second question information and its corresponding prediction confidence may be obtained. Since the prediction confidence indicates the predicted probability that the corresponding predicted intent is the true intent (i.e., the target intent) of the second question information or the first question information, when the prediction confidence is sufficiently high, the corresponding predicted intent may be considered the true intent. The intent prediction result of the second model may be directly used, eliminating the need to call the main model to determine the target intent corresponding to the first question information. This may further reduce the startup time of the main model and reduce the power consumption of the electronic device.

In one embodiment, a minimum confidence that indicates a sufficiently high prediction confidence may be preconfigured, corresponding to a predicted intent being a true intent, which may be recorded as a confidence threshold, such as 85% or 90%. The present disclosure does not limit the value of the confidence threshold, and its representation may be consistent with the representation of the prediction confidence, including but not limited to prediction probability or prediction score. Based on this, it may be determined whether the prediction confidence of each predicted intent corresponding to each piece of second question information obtained by the second model is larger than or equal to the confidence threshold, thereby determining whether it is a true intent among all the predicted intents corresponding to the second question information.

At S35, when it is determined that the prediction confidence of at least one predicted intent corresponding to the various pieces of second question information is larger than or equal to the confidence threshold, the at least one predicted intent is determined as the target intent corresponding to the first question information.

After comparing the prediction confidence of each predicted intent with the confidence threshold, when it is determined that the prediction confidence of the at least one predicted intent corresponding to each piece of second question information is larger than or equal to the confidence threshold, it may mean that the second model has identified at least one true intent for each piece of second question information. Since the first question information includes the second question information, it may mean that the intent prediction result of the second model includes the true intent of the first question information. By comparing the prediction confidence with the confidence threshold, the target intent corresponding to the first question information, that is, the true intent, may be quickly and reliably determined. There may be no need to start the large model to process the predicted intents or the k candidate intents selected therefrom, which greatly reduces the startup time of the large model, reduces the time occupied by the computing and memory resources of the electronic device because of starting the large model, and reduces the power consumption of the electronic device.

At S36, when it is determined that the prediction confidence of each predicted intent corresponding to each piece of second question information is less than the confidence threshold, at least each predicted intent is input into the first model, and the first model processes each predicted intent based on at least the intent description information of each predicted intent to determine the target intent corresponding to the first question information.

After the comparison processing of S34, it may be determined that the intent prediction of the second model is inaccurate, that is, the prediction confidence of each predicted intent corresponding to all the second question information may be less than the confidence threshold, and the predicted intent cannot be directly used to determine the target intent corresponding to the first question information. At this time, to determine the true intent, it may still be necessary to call the first model to determine the target intent corresponding to the first question information. In one possible implementation, the predicted intents obtained by the second model from the input second question information may be directly input into the first model for processing, and the first model’s own knowledge may be used to process the input predicted intents to accurately determine the target intent corresponding to the first question information.

In another possible implementation, the intent description information of each predicted intent may be obtained, and at least each predicted intent and its corresponding intent description information may be used to form intent processing prompt information. Therefore, the intent processing prompt information may be input into the first model, and the first model may process each predicted intent obtained by the second model based on at least the intent description information of each predicted intent, to determine the target intent corresponding to the first question information.

Optionally, according to actual needs, combined with the description of the corresponding part of the above embodiments, in one embodiment, historical interaction information may be combined to form intent processing prompt information to be input into the first model, and the first model may process each predicted intent based on the intent description information of each predicted intent and the historical interaction information to determine the target intent. In this processing process, the first model may also process each predicted intent in combination with the obtained first question information, etc. The present disclosure does not limit how the first model processes the predicted intent and determines the target intent corresponding to the first question information. The content of the intent processing prompt information in different implementation methods may be adaptively adjusted, including but not limited to the content listed above.

It should be understood that after fine-tuning the parameters of the large model using the intent description information of each predicted intent in advance, when using the adjusted large model to process each predicted intent, it may no longer be necessary to input the intent description information into the first model, and the target intent corresponding to the first question information may be accurately determined. For the parameter fine-tuning implementation process of the large model, references may be made to the corresponding part of the above embodiments, that is, the relevant description of the implementation steps of fine-tuning the parameters of the first model using the fine-tuning data obtained from the candidate intents, which will not be described in detail here.

In some other embodiments, combined with the method for determining the target intent corresponding to the first question information described in above embodiments, after S34, when it is determined that the predicted intent in the second processing result of each piece of second question information obtained using the second model is not accurate, that is, when it is determined that the prediction confidence of at least one predicted intent corresponding to each piece of second question information is larger than or equal to the confidence threshold, the k candidate intents may still be selected from the obtained predicted intents based on the prediction confidence, and then at least the candidate intents may be input into the first model (or the tuned first model obtained according to the parameter fine-tuning method described above) for processing. The first model may process the k candidate intents based on at least the intent description information of each of the k candidate intents (which may be input into the first model as a component of the intent processing prompt information, or pre-set in the first model, or the first model pre-learns the intent description information of each type of intent, such that each candidate intent can be correctly understood, etc.) to accurately determine the target intent corresponding to the first question information. The present disclosure does not limit the source of the intent description information.

Optionally, in the process of constructing the intent processing prompt information, in addition to the candidate intents and their corresponding intent description information described above, historical interaction information matching the first question information may also be obtained as needed. Of course, the historical interaction information may also be retrieved by the large model after receiving the input information. Thereafter, based on the intent description information and historical interaction information of each candidate intent, the target intent corresponding to the first question information may be determined.

At S37, when it is determined that the predicted confidence of the predicted intents corresponding to at least one piece of second question information among multiple pieces of second question information is less than the confidence threshold, at least the candidate intents among the predicted intents corresponding to the at least one piece of second question information are input into the first model, and the first model processes the candidate intents at least based on the intent description of the candidate intents to determine the target intent corresponding to the second question information and the predicted intent corresponding to other second question information whose prediction confidence is larger than or equal to the confidence threshold as the target intent corresponding to the first question information.

In an embodiment of the present disclosure, after comparison in S34, it may be determined that the predicted confidence of the predicted intents corresponding to at least one piece of second question information among the multiple pieces of second question information is less than the confidence threshold, and the predicted confidence of at least one predicted intent corresponding to other second question information (that is, at least one other second question information among the multiple pieces of second question information) is larger than or equal to the confidence threshold, indicating that the second model accurately predicts the intent of a part of the second question information constituting the first question information and inaccurately predicts the intent of another part of the second question information. To more accurately determine the target intent corresponding to the first question information, the first model may still be called to process the predicted intents corresponding to this part of the second question information with inaccurate intent prediction, and accurately determine the target intent corresponding to this part of the second question information, and together with the predicted intent of the other part of the second question information accurately predicted by the second model (whose prediction confidence is larger than or equal to the confidence threshold) constitute the target intent of the first question information.

It can be seen that the second question information may include multiple clauses, and the intent complexity of different clauses may be different. The first model decomposes the complex question and obtains multiple pieces of second question information with different intent complexity and expression clarity, which leads to different intent prediction accuracy of the second model for different second question information. In this case, in the present disclosure, S37 may be performed to call the large model to accurately determine the target intent corresponding to the second question information whose intent cannot be accurately predicted by the second model, that is, the real intent corresponding to the second question information. In the process of calling the large model to determine the target intent corresponding to the second question information, the candidate intent in the predicted intent corresponding to this part of the second question information may be determined at S37, and then at least the candidate intents may be input into the first model for processing; or at least the candidate intents and the corresponding intent description information, and even historical interaction information may be input into the first model for processing. For the implementation process, references may be made to the description of the corresponding part of the above embodiments.

In another possible implementation, at S37, when the large model is called to determine the target intent corresponding to the second question information, the predicted intent corresponding to this portion of the second question information may be directly input into the first model for processing. Alternatively, the predicted intent, along with the intent description information and/or historical interaction information corresponding to the predicted intent, may be input into the first model (this information may also be combined to form fixed-format intent processing prompt information and then input into the first model). The first model, then, may process the predicted intent corresponding to this portion of the second question information based on the received intent description information and/or historical interaction information to determine the target intent corresponding to the second question information.

In the present disclosure, the large model may be used to decompose the complex first question information into the at least one piece of second question information with a single or simple intent. To shorten the intent recognition response time, the second model may be used to perform intent recognition processing on each piece of second question information, predicting at least one predicted intent corresponding to each piece of second question information and its corresponding prediction confidence. The accuracy of the second model’s intent prediction may then be determined by comparing each prediction confidence with the confidence threshold. When each piece of second question information has an accurate predicted intent, it may be directly determined as the target intent without further invoking the large model. When none of the predicted intents are accurate, or if the intent predictions for some of the second question information are inaccurate, the large model may then be invoked to determine the target intent corresponding to the first question information. Compared to invoking the large model to implement the entire intent recognition method, in the present disclosure, the startup time of the large model may be reduced, the system latency may be reduced, and the time occupying electronic device resources may be reduced, thereby reducing power consumption and ensuring that the intent recognition method is reliably applicable to resource-limited end-side devices (such as user terminals).

In some other embodiments, after the comparison in S34, when the prediction confidence of at least one predicted intent of at least one piece of second question information is determined to be larger than or equal to the confidence threshold, the predicted intent may be determined as the target intent corresponding to the first question message, without further invoking the large model to process other predicted intents or candidate intents determined therefrom.

It should be noted that in the aforementioned embodiments, when the large model processes the candidate/predicted intents and determines the target intent corresponding to the first question message, the processing methods performed by the large model may include, but are not limited to, intent selection or ranking, which may be determined based on actual circumstances or according to pre-configured intent processing prompts. For example, for the intent processing prompt for the intent “greeting,” this intent may be selected as the target intent when the user query (i.e., the first question information input by the user) is a greeting. For the intent processing prompt for the intent “information request,” this intent may be selected as the target intent when the user requests information or detailed information on a specific topic. For the intent processing prompt of the intent “problem-solving,” this intent may be selected as the target intent when the user expresses a problem or challenge that they are facing and seeks help. For example, when the first question information is “Good morning! I am looking for best practices for sustainable living,” the large model may perform the processing task of selecting the most appropriate intent from given intents (such as the predicted intent or candidate intent mentioned above) based on the user query according to the method described above. It may determine which of the three types of intents mentioned above is most suitable for the first question information input by the user, that is, the target intent corresponding to the first question information may be determined and the reasons for selecting the target intent may also be output, etc.

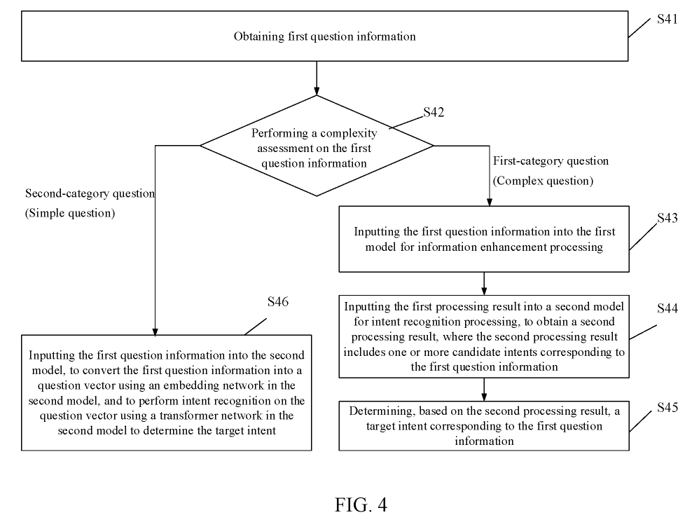

FIG. 4 is a flowchart of another intent recognition method provided by another embodiment of the present disclosure. This embodiment, in addition to the intent recognition method described above, may also determine whether the question information input by the user is complex or simple. Simple question information may be directly processed using the second model without activating the first model, further improving the intent recognition response speed. As shown in FIG. 4, in the present embodiment, the intent recognition method may include S41 to S47:

At S41, first question information input by a user is obtained.

At S42, a complexity assessment is performed on the first question information to determine whether the first question information belongs to a target-category question.

In the embodiments of the present disclosure, complexity assessment methods such as semantic analysis and/or sentence structure analysis may be used to determine whether the first question information belongs to a first-category question (i.e., complex questions with multiple or complex intents) or a second-category question (i.e., simple questions with a single or simple intent). The complexity of questions in the first category may be higher than that of questions in the second category. The present disclosure does not limit the question complexity assessment method.

In some embodiments, a question classification model may be pre-trained to determine the question category of the first question information. Training questions with category labels, i.e., a training dataset, may be obtained and fed into a classifier for training. A question classification model may be obtained that meets training termination criteria (e.g., convergence of question classification accuracy or prediction loss between the predicted question category and the category label, or reaching a specified number of training cycles). The present disclosure does not restrict the training implementation method for the question classification model.

The category labels for the training questions may be determined based on the intent recognition results of the first and second models for the corresponding training questions. For example, the first and second models may be used to identify the intent of the same training problem, to obtain the intents of the training question. When the intents obtained by the first and second models are the same and both are the true intent of the training question, the training question may be considered as a simple question and assigned a category label of the second category. When the intents obtained by the first and second models are different, and the intent obtained by the first model is the true intent of the training question, but the intent obtained by the second model is not the true intent of the training question, the training question may be considered a complex problem and assigned a category label of the first category.

It should be noted that the present disclosure includes, but is not limited to the above-mentioned category label determination methods. Alternatively, in another embodiment, the second model may be used directly to identify the intents of the training data. Based on whether the obtained intent is accurate or whether the match between the intent and the true intent meets a matching threshold (such as the minimum matching degree needed to consider the intent as the true intent, which is not limited in the present disclosure), the training question may be determined to be a complex question or a simple question, and the corresponding category label may be obtained.

Based on this, the first question information input by the user may be input into the question classification model for complexity assessment to determine whether the first question information belongs to the target-category question that matches the complexity assessment result, such as a complex question or a simple question. The present disclosure does not limit the implementation process of the question classification model for complexity assessment of the input first question information. The complexity assessment result may be a category label, which indicates the target-category question; or it may be a predicted probability of the first question information belonging to a complex question or a simple question. The-category question with the higher predicted probability may be determined as the target-category question.

At S43, when the target-category question is the first-category question, the first question information is input into the first model for information enhancement processing to obtain the first processing result, where the first model is a large model.

At S44, the first processing result is input into the second model for intent recognition processing to obtain a second processing result, where the second model is a deep learning model that is able to recognize the intent faster than the large model for the same question information.

At S45, based on the second processing result, the target intent corresponding to the first question information is determined.

In the present disclosure, the first question information input by the user may be determined to belong to the complex question, i.e., the first-category question, and the first question information may be directly assigned to the large model for processing. In this processing process, to address the long response time associated with using only the large model for intent recognition of the first question information and the long-term operation of the large model consumes electronic device resources and results in excessive power consumption, the large model may be used to perform information enhancement processing on the first question information before transmitting it to the second model for intent recognition. Based on the obtained second processing result, the target intent corresponding to the first question information may be quickly and accurately determined, thereby ensuring both accuracy in intent recognition and low latency and power consumption for the intent recognition system. For S43 to S45, references may be made to the description of the corresponding parts of the above embodiments, which will not be elaborated in this embodiment.

At S46, when the target-category question is a second-category question, the first question information is input into the second model. The embedding network in the second model may convert the first question information into a first question vector. The transformer network in the second model may then perform intent recognition on the first question vector to determine the target intent corresponding to the first question information.

When the first question information input by the user is determined to be a simple question, i.e., a second-category question, there may be no need to invoke the main model. Instead, the second model may be directly used to perform intent recognition on the first question information to determine the target intent corresponding to the first question information. For example, among the various predicted intents corresponding to the first question information obtained by the second model, the one with the highest prediction confidence or some predicted intents with higher prediction confidence may be selected and ranked to form the target intent.

To reduce system resource usage, the second model may reuse the embedding network of the main model (i.e., a combination or weighted combination of one or more embedding models in the main model) and combine it with a transformer network with at least one transformer layer, to achieve intent recognition for the first question information. Since the embedding network and converter network of this second model are able to be decoupled, when the system already has an embedding model, such as the embedding model of the large model, this embedding model may be directly reused to form the second model, reducing overall system resource usage. It should be noted that the network structure of the second model for the aforementioned functions of the present disclosure, including but not limited to that described in this embodiment, may be flexibly determined based on actual circumstances.

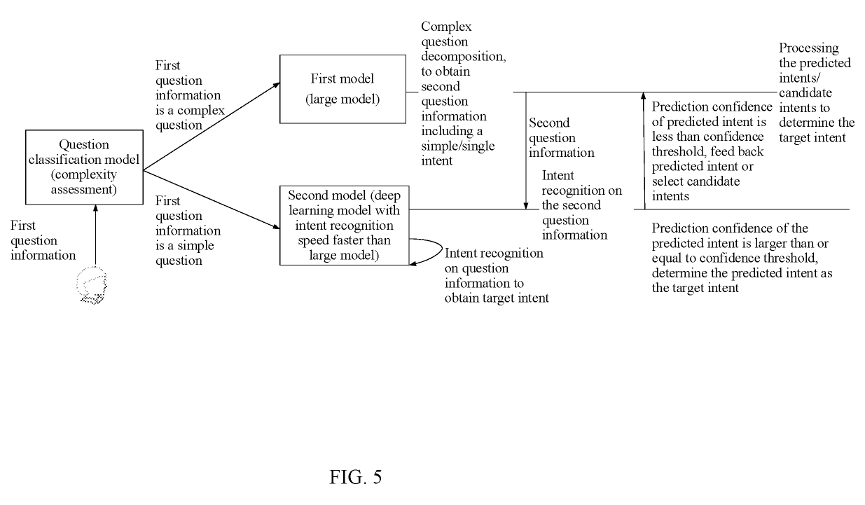

In summary, as shown in the flowchart in FIG. 5, the present disclosure may comprehensively consider the balance between intent recognition accuracy, response time, and power consumption. It may first determine whether the first question information input by the user is complex or simple. The complex question may be assigned to the large model for processing, while the simple question may be assigned to the second model for processing. During the complex question processing, the second model may be used to provide the k candidate intents for the first question information, ensuring that the candidate intents include all possible true intents, thereby improving intent recall, which not only improves the accuracy of intent recognition for complex questions but also ensures low latency and low power consumption for the system.

For the intent recognition methods described in the above embodiments, after determining the target intent corresponding to the first question information input by the user, the corresponding task operation may be performed based on the intent category of at least one intent included in the target intent. Therefore, the intent recognition method may further include, but is not limited to, the following task operation implementation methods.

When the target intent corresponding to the first question information includes a first intent to control an electronic device, that is, a device control intent, in response to a mismatch between the first operating state of the electronic device and a first intent, a device control page matching the first intent may be output. In response to a control input operation on the device control page, the electronic device may be controlled to switch from the first operating state to a second operating state matching the first intent.

The state content of the first operating state and the second operating state may be determined based on the content of the first intent. For example, when the first intent is to turn on the eye protection mode of the electronic device, it may be determined whether the electronic device is in eye protection mode. When it is currently in non-eye protection mode, that is, the eye protection mode is not turned on, the first operating state of the electronic device may not match the first intent and an eye protection mode setting interface may be output for the user to turn on the eye protection mode on the eye protection mode setting interface. In response to the control input operation, the electronic device may be controlled to turn on the eye protection mode, that is, the electronic device may be controlled to enter the second operating state that matches the first intent.

In another possible implementation, in response to the first operating state of the electronic device not matching the first intent, a control button for the eye protection mode may also be output, and in response to the triggering operation of the control button, the eye protection mode of the electronic device may be turned on. Or, the electronic device may be directly controlled to switch from the first operating state to the second operating state that matches the first intent, that is, the eye protection mode of the electronic device may be automatically turned on without user operation.

In one embodiment, in response to the second operating state of the electronic device matching the first intent, corresponding matching prompt information, such as “the eye protection mode is turned on,” may be output. In this case, no processing may be performed to ensure that the electronic device is in the second operating state that matches the first intent.

It should be understood that for the first intent of other device control types, the electronic device may respond to the first intent in a similar manner. The corresponding API may be called to control the electronic device itself or its interconnected devices (such as external imaging devices, speakers, or other electronic devices such as displays). The control process may be similar, and the present disclosure does not provide detailed examples one by one.

When the target intent corresponding to the first question information includes a second intent in the question-and-answer task, such as a content generation/search intent, or an intent implied by the task corresponding to the first question information which is not directly expressed in the first question information, in response to the second intent, the first model may output the target content for answering the first question information based on the second intent.

In the above implementation process, a pre-configured task prompt word corresponding to the second intent may be obtained. At least the task prompt word and the second intent may form the question-and-answer prompt information input into the first model. According to the task prompt word, the first model may be guided to output the target content for answering the first question information based on the second intent. For example, to generate a summary of document A, the task prompt word may be a pre-configured rule for how to generate the summary. The generation implementation process corresponding to other categories of content may be similar, and the present disclosure does not provide detailed description. Of course, in some other embodiments, the task prompt word and the second intent may be directly input into the first model to output the target content. The present disclosure does not limit how the large model performs the question-answering task based on the prompt project.

In the process of responding to the above-mentioned second intent, the user may also interact with the content output by the large model, perform question supplement operations on the first question information based on the prompt information of the question to be supplemented output by the large model, and input the question supplement information into the large model to obtain the target content that meets the user’s expectations. The implementation process is not described in detail.

When the target intent corresponding to the first question information includes a third intent of calling the cloud service, in response to the third intent, a cloud service call interface or a cloud service interaction interface of the called cloud service may be output. The cloud service call interface may display at least one calling method of the intent to call the cloud service. For example, according to the intent recognition method described above, it may be determined that the user inputs the first question information and needs to call the customer service of a certain product. The electronic device may output a customer service call interface including a calling method such as a customer service phone number or a customer service system access address link, or directly request communication with the product’s customer service, or a customer interaction interface (such as a chat window, etc.).

When the target intent corresponding to the first question information includes a fourth intent of launching an application APP, in response to the fourth intent, an application interaction interface of the intent to launch the application may be output. That is, the APP may be directly opened, such as a browser or a Word document, etc. The fourth intent may be the intent directly expressed by the first question information, or it may be determined according to the above-mentioned intent recognition method that the execution of the task needs the launch of the application APP. In this case, the corresponding application interaction interface may be output. The implementation process is not described in detail in the present disclosure.

In the actual application of the present disclosure, after identifying the intent of the first question information and determining that its target intent includes one or more intents listed above, the electronic device may respond to each intent, in accordance with, but not limited to, the processing method of the corresponding intent to meet the task processing needs of the user inputting the first question information.

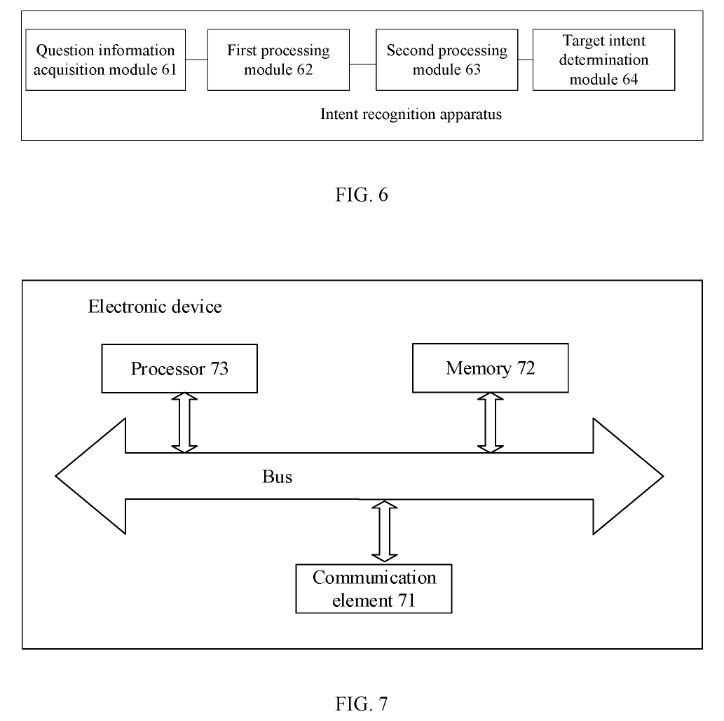

The present disclosure also provides an intent recognition apparatus. As shown in FIG. 6, which is a schematic structural diagram of an intent recognition apparatus consistent with various embodiments of the present disclosure, in one embodiment, the intent recognition apparatus includes:

a question information acquisition module 61, configured to obtain first question information input by a user;

a first processing module 62, configured to input the first question information into a first model for information enhancement processing, thereby obtaining a first processing result;

a second processing module 63, configured to input the first processing result into a second model for intent recognition processing, thereby obtaining a second processing result, where the second processing result includes at least one candidate intent corresponding to the first question information; and

a target intent determination module 64, configured to determine a target intent corresponding to the first question information based on the second processing result.

The first model may be a large model, and the second model may be a deep learning model that is able to recognize intent faster than the large model for the same question information.

In some embodiments, the first processing module 62 may include:

a complex question decomposition unit, configured to: input the first question information into the first model for complex question decomposition, thereby obtaining at least one piece of second question information included in the first question information, where each piece of second question information has a single intent or a simple intent while the first question information may have multiple intents or a complex intent.

Correspondingly, the second processing module 63 may include:

an intent recognition processing unit, configured to input at least one piece of second question information into the second model for intent recognition processing, thereby obtaining the second processing result corresponding to the at least one piece of second question information, where the second processing result may include at least one predicted intent corresponding to the second question information and a prediction confidence corresponding to each predicted intent.

In one embodiment, the target intent determination module 64 may include:

a candidate intent selection unit, configured to select k candidate intents from predicted intents corresponding to each piece of second question information based on the prediction confidence;

an intent description information acquisition unit, configured to obtain intent description information for each candidate intent; and

a first input unit, configured to input at least the k candidate intents and the intent description information of each candidate intent into the first model, such that the first model processes the k candidate intents based on at least the intent description information and determines the target intent corresponding to the first question information.

In one embodiment, the target intent determination module 64 may include at least one of:

a first determination unit, configured to, upon determining that the prediction confidence of at least one predicted intent corresponding to each piece of second question information is larger than or equal to a confidence threshold, determine the at least one predicted intent as the target intent corresponding to the first question information;

a second determination unit, configured to, upon determining that the prediction confidence of each predicted intent corresponding to each piece of second question information is less than the confidence threshold, input at least each predicted intent into the first model, such that the first model processes each predicted intent based on at least the intent description information of each predicted intent to determine the target intent corresponding to the first question information;

a third determination unit, configured to, upon determining that the prediction confidence of each predicted intent corresponding to each piece of second question information is less than the confidence threshold, determine candidate intents of each predicted intent and input the candidate intents to the first model, such that the first model processes the candidate intents based on at least the intent description information of the candidate intents to determine the target intent corresponding to the first question information; or

a fourth determination unit, configured to, when the prediction confidence of the predicted intents corresponding to at least one of the multiple pieces of second question information is less than the confidence threshold, determine a candidate intent from each of the predicted intents corresponding to the at least one piece of second question information, and input at least the candidate intent into the first model, such that the first model processes the candidate intents based on at least the intent description information of the candidate intent to obtain the target intent corresponding to the second question information. The target intent corresponding to the second question information and the predicted intents corresponding to other second question information whose prediction confidence is larger than or equal to the confidence threshold may form the target intent corresponding to the first question information.

In yet other embodiments, the target intent determination module 64 may further include:

a fine-tuning data acquisition unit, configured to obtain fine-tuning data based on the candidate intents or the predicted intents;

a parameter fine-tuning unit, configured to use the fine-tuning data to tune the parameters of the first model to obtain a tuned first model capable of understanding the candidate intents or the predicted intents and processing the candidate intents or the predicted intents using the tuned first model to obtain the target intent.

In some embodiments, the complex question decomposition unit may include at least one of:

a semantic analysis unit, configured to input the first question information into the first model, perform semantic analysis on the first question information and historical question information input adjacent to the first question information, and obtain the at least one piece of second question information included in the first question information; or

a decomposition unit, configured to input the first question information into the first model for intent recognition, and decompose the first question information into multiple pieces of second question information based on the multiple or complex intents included in the first question information.

In some embodiments, the intent recognition apparatus may further include:

a complexity assessment module, configured to: perform a complexity assessment on the first question information to determine whether the first question information belongs to a target-category question, and when the target-category question is a first-category question, trigger the first processing module 62 to input the first question information into the first model for information enhancement processing; and

an intent recognition module, configured to, when the target-category question is a second-category question, input the first question information into the second model, convert the first question information into a first question vector using the embedding network in the second model, and perform intent recognition on the first question vector using the transformer network in the second model to determine the target intent corresponding to the first question information.

The complexity of the first-category question may be higher than that of the second-category question. The first-category question may be a complex question including multiple intents or complex questions. The second-category question may be a simple question including a single or simple answer intent.

In one embodiment, the complexity assessment module may include:

a complexity assessment unit, configured to input the first question information into a question classification model for complexity assessment, and determine whether the first question information belongs to a target-category question that matches the complexity assessment result.

The question classification model may be trained using training questions with category labels to train a classifier, and the category labels may be determined based on intent recognition results of the first and second models for the training questions, respectively.

In some embodiments, the intent recognition apparatus may further include at least one of:

a first response module, configured to, when the target intent includes a first intent to control an electronic device, output a device control page that matches the first intent in response to a first operating state of the electronic device not matching the first intent, and, in response to a control input operation on the device control page, control the electronic device to switch from the first operating state to a second operating state that matches the first intent;

a second response module, configured to, when the target intent includes the first intent to control the electronic device, output a corresponding matching prompt in response to a second operating state of the electronic device matching the first intent;

a third response module, configured to, when the target intent includes a second intent in a question-and-answer task, output target content for answering the first question based on the second intent by the first model;

a fourth response module, configured to, when the target intent includes a third intent to invoke a cloud service, output a cloud service invocation interface or a cloud service interaction interface for the invoked cloud service in response to the third intent, where the cloud service invocation interface presents at least one invocation method for the intended cloud service; or

a fifth response module, configured to, when the target intent includes a fourth intent to launch an application, output an application interaction interface in response to the fourth intent.

The present disclosure also provides a computer program product including computer-readable instructions. When the computer-readable instructions are executed on an electronic device, the electronic device may be configured to implement any intent recognition method provided by various embodiments of the present disclosure.

When the computer-readable instructions are loaded and executed on a computer, the processes or functions described in the present disclosure may be fully or partially generated. The computer may be a general-purpose computer, a special-purpose computer, a computer network, or other programmable device. The computer-readable instructions may be stored in a computer-readable storage medium or transmitted from one computer-readable storage medium to another. For example, the computer-readable instructions may be transmitted from one website, computer, training device, or data center, to another website, computer, training device, or data center via wired (e.g., coaxial cable, optical fiber, digital subscriber line (DSL)) or wireless (e.g., infrared, wireless, microwave, etc.) means to meet the data/instruction transmission needs during the execution of the intent recognition method provided in the present application.

The present disclosure also provides a computer-readable storage medium storing one or more computer programs. When the one or more computer programs are executed by an electronic device, the electronic device may be configured to implement any intent recognition method provided by various embodiments of the present disclosure.

The computer-readable storage medium may be any available medium that a computer can store data or information into, or a data storage device such as a training device or data center that integrates one or more available media. The available media may include a magnetic medium (e.g., a floppy disk, hard disk, or tape), an optical medium (e.g., a DVD), or a semiconductor medium (e.g., a solid-state drive (SSD)).

The present disclosure also provides an electronic device. FIG. 7 is a hardware structure diagram of an electronic device suitable for the intent recognition method provided by any embodiment of the present disclosure. The electronic device may include, but is not limited to, a mobile phone, a tablet computer, a wearable device, an in-vehicle device, an augmented reality (AR)/virtual reality (VR) device, a laptop computer, a netbook, a robot, or a business terminal. A server may also be configured to implement the intent recognition method provided by any embodiment of the present disclosure.

As shown in FIG. 7, the electronic device includes, but is not limited to: at least one communication element 71, at least one memory 72, and at least one processor 73.

The at least one communication element 71, the at least one memory 72, and the at least one processor 73 may communicate with each other via a bus. The bus may be a peripheral component interconnect (PCI) bus or an extended industry standard architecture (EISA) bus. Buses can be divided into address buses, data buses, control buses, and so on. For ease of illustration, FIG. 7 shows only one bidirectional line, but this does not imply that there is only one bus or only one type of bus.

The at least one communication element 71 may be used to receive the first question information input by the user, enable communication between components within the electronic device, and between the electronic device and the server to transmit data or instructions needed during the execution of the intent recognition method. For example, when invoking the large model to execute a corresponding step, the server deploying the large model may send corresponding instructions and data (such as the first question information, candidate intents/predicted intents, and, if necessary, pre-configured task processing prompts matching the determined target intent) and receive a response from the server based on the large model feedback, such as the target content output by the large model in response to the target intent, which is used to answer the first question information.

The at least one communication element 71 may include a communication element that supports wireless communication methods such as Wi-Fi, Bluetooth, or 5G/6G mobile communications, to enable the electronic device to transmit data to other devices via the communication element. It may also include one or more interfaces that support wired communication methods, such as a general-purpose input/output (GPIO) interface, a USB interface, or a universal asynchronous receiver/transmitter (UART) interface, to facilitate data transmission between various components within the electronic device. The present disclosure does not limit the structure of the at least one communication element 71 and its corresponding communication transmission mechanism for implementing this function, which may be determined according to actual conditions.

The at least one memory 72 may be used to store computer program instructions that implement the intent recognition method provided by any embodiment of the present disclosure. The at least one processor 73 may load and execute the computer program instructions stored in the memory 72 to implement the various steps of the intent recognition method provided by any embodiment of the present disclosure. The implementation process may refer to the description of the corresponding sections of the method embodiments above.

In one embodiment, the at least one memory 72 may include the various storage media listed above. The at least one processor 71 may include any one or more of a central processing unit (CPU), a graphics processing unit (GPU), a microprocessor (MP), a digital signal processor (DSP), an application-specific integrated circuit (ASIC), or a field-programmable gate array (FPGA).

It should be understood that the structure of the electronic device shown in FIG. 7 does not limit the electronic device in the embodiments of the present disclosure. In actual applications, the electronic device may include more or fewer components than those shown in FIG. 7, or a combination of certain components, such as a microphone (which can collect user input voice signals), a speaker, a display, various sensors, an antenna, a power supply module, a radio frequency component, external ports, and other input/output components. This can be determined based on processing function needs, and the present disclosure does not provide detailed examples.

It should also be noted that the apparatus embodiments described above are merely illustrative. The units described as separate components may or may not be physically separate. The components shown as units may or may not be physical units, that is, they may be located in one location or distributed across multiple network units. Some or all of the modules can be selected based on actual needs to achieve the objectives of these embodiments. Furthermore, in the apparatus embodiments drawings provided herein, the connections between modules indicate a communication connection between them, which can be implemented as one or more communication buses or signal lines.

Through the above description of the embodiments, those skilled in the art will clearly understand that the present disclosure can be implemented using software plus necessary general-purpose hardware. Of course, it can also be implemented using specialized hardware, including application-specific integrated circuits, dedicated CPUs, dedicated memories, and dedicated components. Generally speaking, any function performed by a computer program can be easily implemented using the corresponding hardware. Furthermore, the specific hardware structures used to implement the same function can vary, such as analog circuits, digital circuits, or dedicated circuits. In some embodiments, software implementation is often the preferred implementation method. Based on this understanding, the technical solution of the present disclosure or the portion that contributes to the prior art, may be embodied in the form of a software product. This computer software product may be stored on a readable storage medium, such as a computer floppy disk, a USB flash drive, a removable hard drive, a ROM, a RAM, a magnetic disk, or an optical disk, and may include instructions for enabling a computer device (which may be a personal computer, training device, or network device, etc.) to execute the methods provided by any embodiment of the present disclosure.

In the above embodiments, all or part of the methods may be implemented using software, hardware, firmware, or any combination thereof. When implemented using software, all or part of the methods can be implemented in the form of a computer program product. The various embodiments of the present disclosure are described in a progressive or parallel manner, with each embodiment focusing on the differences from other embodiments. Similar or identical portions between the various embodiments can be referenced separately. As for the devices and electronic devices disclosed in the embodiments, since they correspond to the methods disclosed in the embodiments, the description is relatively simple. For relevant details, references may be made to the method embodiments.

The above describes in detail a plurality of embodiments of the present disclosure, but the present disclosure is not limited to these specific embodiments. Those skilled in the art can make various variations and modifications based on the concept of the present disclosure, and these variations and modifications shall fall within the scope of the present disclosure.

What is claimed is:

1. An intent recognition method comprising:
obtaining question information;
inputting the question information into a first model for information enhancement processing, to obtain a first processing result;
inputting the first processing result into a second model for intent recognition processing, to obtain a second processing result that includes at least one candidate intent corresponding to the question information; and
determining, based on the second processing result, a target intent corresponding to the question information;
wherein the first model is a large model and the second model is a deep learning model with an intent recognition speed faster than the large model for same question information.

2. The method according to claim 1, wherein:
the question information is first question information;
inputting the first question information into the first model for information enhancement processing includes:
inputting the first question information into the first model for complex question decomposition, to obtain at least one piece of second question information included in the first question information, each of the at least one piece of second question information having a single intent or a simple intent, and the first question information having multiple intents or a complex intent; and
inputting the first processing result into the second model for intent recognition processing includes:
inputting the at least one piece of second question information into the second model for intent recognition processing, to obtain the second processing result corresponding to the at least one piece of second question information, the second processing result including one or more predicted intents and one or more prediction confidences each corresponding to one of the one or more predicted intents, and each of the at least one piece of second question information corresponding to one or more of the one or more predicted intents.

3. The method according to claim 2, wherein determining the target intent includes:
selecting one or more candidate intents from the one or more predicted intents based on the one or more prediction confidences;
obtaining intent description information of each of the one or more candidate intents; and
inputting at least the one or more candidate intents and the intent description information of each of the one or more candidate intents into the first model, to enable the first model to process the one or more candidate intents based at least on the intent description information to determine the target intent corresponding to the first question information.

4. The method according to claim 3, wherein determining the target intent further includes:
obtaining fine-tune data based on the one or more candidate intents or the one or more predicted intents;
performing, using the fine-tuning data, parameter tuning on the first model to obtain a tuned first model capable of understanding the one or more candidate intents or the one or more predicted intents; and
processing the one or more candidate intents or the one or more predicted intents using the tuned first model to obtain the target intent.

5. The method according to claim 2, wherein determining the target intent includes:
determining that the prediction confidence of at least one predicted intent of the one or more predicted intents is larger than or equal to a confidence threshold; and
determining the at least one predicted intent as the target intent.

6. The method according to claim 2, wherein determining the target intent includes:
determining that the prediction confidence of each of the one or more predicted intents is less than a confidence threshold; and
inputting at least the one or more predicted intents into the first model, to enable the first model to process each of the one or more predicted intents based at least on the intent description information of the corresponding predicted intent to determine the target intent.

7. The method according to claim 2, wherein determining the target intent includes:
determining that the prediction confidence of each of the one or more predicted intents is less than a confidence threshold; and
determining one or more candidate intents from the one or more predicted intents and inputting at least the one or more candidate intents into the first model, to enable the first model to process the one or more candidate intents based at least on the intent description information of the one or more candidate intents to determine the target intent.

8. The method according to claim 2, wherein:
the target intent corresponding to the first question information is a first target intent;
the at least one piece of second question information includes a plurality of pieces of second question information; and
determining the first target intent includes:
determining that the plurality of pieces of second question information include at least one first piece of second question information and at least one second piece of second question information, the prediction confidence of each predicted intent corresponding to each of the at least one first piece of second question information being less than a confidence threshold, and the prediction confidence of at least one predicted intent corresponding to each of the at least one second piece of second question information being larger than or equal to the confidence threshold; and
determining one or more candidate intents from the or more predicted intents corresponding to the at least one first piece of second question information, and inputting at least the one or more candidate intents into the first model, to enable the first model to process each of the one or more candidate intents based at least on the intent description information of the corresponding candidate intent to obtain one or more second target intents each corresponding to one of the at least one first piece of second question information;
wherein the first target intent includes the one or more second target intents and one or more predicted intents corresponding to the at least one second piece of second question information with prediction confidence larger than or equal to the confidence threshold.

9. The method according to claim 2, wherein inputting the first question information into the first model for complex question decomposition includes:
inputting the first question information into the first model to perform semantic analysis on the first question information and historical question information input adjacent to the first question information, to obtain the at least one piece of second question information.

10. The method according to claim 2, wherein inputting the first question information into the first model for complex question decomposition includes:
inputting the first question information into the first model for intent recognition, to decompose the first question information into a plurality of pieces of second question information based at least on a plurality of intents or a complex intent of the first question information.

11. The method according to claim 1, further comprising:
performing a complexity assessment on the question information;
in response to the complexity assessment indicating that the question information belongs to a first-category question, inputting the question information into the first model for information enhancement processing; and
in response to the complexity assessment indicating that the question information belongs to a second-category question, inputting the question information into the second model, to convert the question information into a question vector using an embedding network in the second model, and to perform intent recognition on the question vector using a transformer network in the second model to determine the target intent;
wherein a complexity of the first-category question is higher than as complexity of the second-category question.

12. The method according to claim 11, wherein:
performing the complexity assessment on the question information includes inputting the question information into a question classification model for complexity assessment, to determine that the question information belongs to a target-category question that matches a complexity assessment result; and
training the question classification model is obtained by training a classifier using training questions with category labels, the category labels being determined based on intent recognition results of the first model and the second model for the training questions.

13. The method according to claim 1,
wherein the target intent includes a control intent to control an electronic device;
the method further comprising:
in response to a first operating state of the electronic device not matching the control intent:
outputting a device control page matching the control intent; and
in response to a control input operation on the device control page, controlling the electronic device to switch from the first operating state to a second operating state matching the control intent.

14. The method according to claim 1,
wherein the target intent includes a control intent to control an electronic device;
the method further comprising:
in response to an operating state of the electronic device matching the control intent, outputting a corresponding matching prompt.

15. The method according to claim 1,
wherein the target intent includes a task intent in a question-and-answer task;
the method further comprising:
outputting, through the first model, target content for answering the question information based on the task intent.

16. The method according to claim 1,
wherein the target intent includes an invocation intent to invoke a cloud service;
the method further comprising:
outputting a cloud service invocation interface or a cloud service interaction interface of the cloud service in response to the invocation intent, the cloud service invocation interface displaying at least one invocation method for the cloud service.

17. The method according to claim 1,
wherein the target intent includes a launching intent to launch an application;
the method further comprising:
in response to the launching intent, outputting an application interaction interface of the application.

18. An electronic device comprising:
at least one memory storing program instructions; and
at least one processor configured to execute the program instructions to:
obtain question information;
input the question information into a first model for information enhancement processing, to obtain a first processing result;
input the first processing result into a second model for intent recognition processing, to obtain a second processing result that includes at least one candidate intent corresponding to the question information; and
determine, based on the second processing result, a target intent corresponding to the question information;
wherein the first model is a large model and the second model is a deep learning model with an intent recognition speed faster than the large model for same question information.

19. The electronic device according to claim 18, wherein:
the question information is first question information; and
the at least one processor is further configured to execute the program instructions to:
when inputting the first question information into the first model for information enhancement processing:
input the first question information into the first model for complex question decomposition, to obtain at least one piece of second question information included in the first question information, each of the at least one piece of second question information having a single intent or a simple intent, and the first question information having multiple intents or a complex intent; and
when inputting the first processing result into the second model for intent recognition processing:
input the at least one piece of second question information into the second model for intent recognition processing, to obtain the second processing result corresponding to the at least one piece of second question information, the second processing result including one or more predicted intents and one or more prediction confidences each corresponding to one of the one or more predicted intents, and each of the at least one piece of second question information corresponding to one or more of the one or more predicted intents.

20. A non-transitory computer-readable storage medium storing program instructions that, when executed by a processor, cause an electronic device including the processor to:
obtain question information;
input the question information into a first model for information enhancement processing, to obtain a first processing result;
input the first processing result into a second model for intent recognition processing, to obtain a second processing result that includes at least one candidate intent corresponding to the question information; and
determine, based on the second processing result, a target intent corresponding to the question information;
wherein the first model is a large model and the second model is a deep learning model with an intent recognition speed faster than the large model for same question information.
